(19) United States
(12) Patent Application Publication
(10) Pub. No.: US 2024/0105945 A1
(43) Pub. Date: Mar. 28, 2024

(54) NOVEL ORGANIC ELECTRODES AND THEIR USE IN ELECTROCHEMICAL SYSTEMS

(71) Applicants: ELECTRICITE DE FRANCE, PARIS (FR); CENTRE NATIONAL DE LA RECHERCHE SCIENTIFIQUE (CNRS), PARIS (FR); UNIVERSITE DE PICARDIE JULES VERNE (UPJV), AMIENS CEDEX (FR)

(72) Inventors: Roberto RUSSO, LATINA (IT); Philippe STEVENS, NOISY RUDIGNON (FR); Gwenaëlle TOUSSAINT, NEMOURS (FR); Matthieu BECUWE, BERNAVILLE (FR)

(73) Assignees: ELECTRICITE DE FRANCE, PARIS (FR); CENTRE NATIONAL DE LA RECHERCHE SCIENTIFIQUE (CNRS), PARIS (FR); UNIVERSITE DE PICARDIE JULES VERNE (UPJV), AMIENS CEDEX (FR)

(21) Appl. No.: 18/459,681

(22) Filed: Sep. 1, 2023

(30) Foreign Application Priority Data
Sep. 1, 2022 (FR) 2208778

(51) Int. Cl. H01M 4/60; H01M 4/04; H01M 4/139; H01M 10/052; H01M 10/0568; H01M 10/0569

(52) U.S. Cl. CPC H01M 4/60; H01M 4/0404; H01M 4/0409; H01M 4/139; H01M 10/052; H01M 10/0568; H01M 10/0569; H01M 2004/028

(57) ABSTRACT

Positive electrodes based on organic active material, including molecules of thianthrene as the active material, substituted at specific positions. The electrodes have electrochemical properties enabling their use in a battery, in particular a recyclable battery. The electrodes thus replace the electrodes based on mineral salts that are conventionally used in batteries.

### FIELD

The present invention relates to the field of electrochemical energy storage. In particular, it concerns the provision of new organic electrodes and their use in electrochemical systems, in particular in a rechargeable battery.

### BACKGROUND

Rechargeable batteries are essential components in many devices, such as cell phones, computers, and vehicles. However, the vast majority of rechargeable batteries are composed of electrodes comprising minerals as the active material. Most of the positive electrodes contained in rechargeable batteries are therefore “inorganic” electrodes. These electrodes comprise inorganic compounds as the reversible redox active material, in particular compounds of transition metals such as LiCoO₂, LiNiO₂, LiMn₂O₄, mixed compounds such as Li(Ni_{1/3}Co_{1/3}Mn_{1/3})O₂, or compounds based on iron phosphate.

However, these electrodes based on inorganic active material have major disadvantages. Apart from the high toxicity and fire hazard issues of these inorganic batteries, there are ecological and economic issues. Indeed, these inorganic compounds are difficult to recycle, and come from non-renewable resources, which poses a potential supply problem as there is a growing demand for this type of battery. In addition, production of the inorganic active material used in a positive electrode of batteries is energy-intensive and a source of concomitantly produced greenhouse gases.

In light of these findings, positive electrodes that contain no minerals have been considered in the past. These “organic” positive electrodes comprise organic elements available in more abundant quantities as the active materials, such as carbon, hydrogen, oxygen, sulfur, phosphorus, etc.

These organic redox compounds can even be biosourced from plants. Such batteries offer the advantage of having a very low carbon footprint, of being produced farom abundant resources, and of using energy-efficient processes which are carried out at low temperatures. The organic nature of the active material also makes these batteries easier to recycle, and even partly biodegradable.

However, these organic redox compounds often need to be immobilized within the electrode in order to provide an electronically conductive component and in particular to avoid their dissolution in the electrolyte. Electrodes have therefore been developed which have, as their active material, a redox organic compound immobilized on carbon or grafted on a polymer. These solutions are unsatisfactory, however, because the level of redox compounds is low due to the presence of an electronically conductive filler or of a polymer to stabilize them.

Electrodes based on small non-polymeric organic molecules have also been developed. Thus, patent JPS6315703 B2 describes an organic lithium battery comprising a positive electrode comprising a phenanthrene derivative, for example 9,10-phenanthrenequinone, as an active material. A battery comprising this electrode has good discharge capacity, but the reversibility of the reduction-oxidation reactions is insufficient and the average discharge voltage is relatively low (i.e. in the order of 2-2.5 volts).

Moreover, for most organic batteries based on small non-polymeric molecules, it has been observed that the specific capacity (defined as the electrical charge that the battery can provide from a fully charged state until its complete discharge, per mass unit) drops after several charge-discharge cycles, a sign of poor cycling stability. Also, these electrodes suffer from significant self-discharge.

In addition, the low electronic and ionic conductivity of the organic active materials known in the state of the art generally requires the addition of a large quantity of electronic conductor which does not contribute to the redox reaction of electricity storage/release. This electronic conductor can represent up to 70% of the mass of the electrode, excluding the weight of the current collector. The porosity of the electrode must also be adjusted to allow sufficient electrolyte to penetrate to ensure ionic percolation in the electrode, which has an impact on the maximum amount of active material per unit area of the electrode's current collector.

There is therefore a need to provide new electrodes which contain no minerals and have electrochemical properties compatible with use in a battery, in particular a rechargeable battery. It is desirable in particular to provide an organic battery having a good discharge voltage (in particular greater than 4 V), a good specific capacity, as well as good cycling stability in order to allow sufficient charge-discharge cycles.

It is to the credit of the inventors that they have developed a positive electrode based on organic active material which meets these needs.

### SUMMARY

A first object of the present invention is a positive electrode based on organic active material, comprising, preferably consisting of:
an organic active material,
an electronically conductive material, and
a current collector,
   wherein the active material is a redox compound of Formula 1:

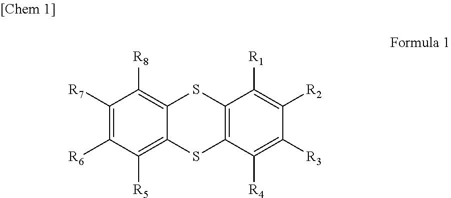

wherein:
R₁, R₂, R₃, R₄, R₅, R₆, R₇ and R₈ are independently selected among:
   a hydrogen atom,
   a halogen, in particular selected among fluorine, chlorine, and bromine, in particular a fluorine,
or a group selected among:
   C₁ to C₅₀ linear or branched alkyl,
C₁ to C₅₀ linear or branched fluoroalkyl, in particular —CF₃,
—CO₂H, optionally in salified form,
—SO₂OH, optionally in salified form,
—PO(OH)₂, optionally in salified form,
—PO(ORₐ)₂, where Rₐ is a C₁ to C₁₀ linear or branched alkyl group, in particular CH₃,
—CN,
amine,
—OH,
—OR_{b}, where R_{b} is a C₁ to C₅₀ linear or branched alkyl group,
—CHO,
—CO—R_{c}, where R_{c} is a C₁ to C₅₀ linear or branched alkyl group, and wherein:
   R₁, R₂, R₃, R₄, R₅, R₆, R₇ and R₈ are different from H, or
   R₁, R₄, R₅, and R₈ are H, and R₂, R₃, R₆ and R₇ are different from H, or
   R₁, R₃, R₄, R₅, R₇, and R₈ are H, and R₂ and R₆ are different from H.

“C₁ to C₅₀ linear alkyl” is understood to mean a linear alkyl chain of 1 to 50 carbon atoms. “C₁ to C₅₀” is understood to mean the following ranges in particular: C₁ to C₂₀, C₁ to C₂₀, C₁ to C₁₀, and C₁ to C₅. The linear alkyl group is in particular a methyl, ethyl, propyl, butyl, or pentyl group, in particular a methyl group.

“Branched alkyl” is to be understood as meaning an alkyl group as defined above, comprising substituents selected from the list of linear alkyl groups defined above, said linear alkyl groups also being able to be branched. Among the branched alkyl groups, particular mention can be made of a tert-butyl, sec-butyl, and isopropyl group.

“C₁ to C₅₀ fluoroalkyl” is understood to mean a C₁ to C₅₀ alkyl group as defined above, comprising one or more fluorine atoms in place of the hydrogen atoms. The fluoroalkyl group is in particular a CF₃ group.

The —CO₂H group, or carboxylic acid, can optionally be in the form of a carboxylate group, in particular in the form of a metal salt such as a sodium salt, a potassium salt, or a lithium salt. An organic salt is also possible, for example such as an ammonium salt.

The —SO₂OH group, or sulfonic acid, may optionally be in the form of a sulfonate group, in particular in the form of a metal salt such as a sodium salt, a potassium salt, or a lithium salt. An organic salt is also possible, for example such as an ammonium salt.

The —PO(OH)₂ group, or phosphonic acid, may optionally be in the form of a phosphonate group, in particular in the form of a metal salt such as a sodium salt, a potassium salt, or a lithium salt. An organic salt is also possible, for example such as an ammonium salt.

“Amine” group is understood to mean a primary amine (—NH₂), a secondary amine of formula —NH(R_{d}), a tertiary amine of formula —N(R_{d})(Rₑ), or a quaternary amine of formula —N⁺(R_{d})(Rₑ)(R_{f})X⁻.

R_{d}, Rₑ, and R_{f} are selected independently of one another among a C₁ to C₅₀ linear or branched alkyl group, in particular CH₃, or an aryl group, in particular phenyl.

X⁻ in said —N⁺(R_{d})(Rₑ)(R_{f})X⁻ group is in particular a counterion selected among hydroxyl, bromide, chloride or iodide, or else an organic counterion, for example such as acetate.

Said primary amine, secondary amine, or tertiary amine are optionally in the form of an ammonium salt, in which the counterion is selected in particular among hydroxyl, bromide, chloride, or iodide, or else an organic counterion, for example such as acetate.

The positive electrode according to the invention comprises, as the organic active material, a redox (reduction-oxidation) compound of Formula 1. The redox compound of Formula 1 corresponds to a molecule of thianthrene, substituted at specific positions.

Conventionally, thianthrene-based compounds are capable of reversibly exchanging an electron during a redox reaction with insertion of a counteranion A⁻. In the context of a battery in which a thianthrene-based positive electrode is contained, the anion A⁻ comes from the electrolyte, in which a salt comprising said anion A⁻ is present (Diagram 1).

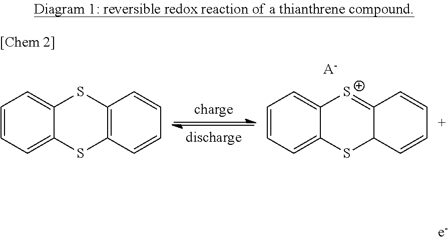

The presence of specific substituents in the redox compound of Formula 1 according to the invention makes it possible to adjust the redox potential of the molecule, and in the most advantageous case to exchange two electrons, sequentially, with insertion of two anions A⁻(Diagram 2). Compared to a one-electron process observed for unsubstituted thianthrene, this two-electron redox process allows storing twice as much charge (since twice as many electrons can be exchanged), when the electrode is used within a battery, which provides an obvious advantage.

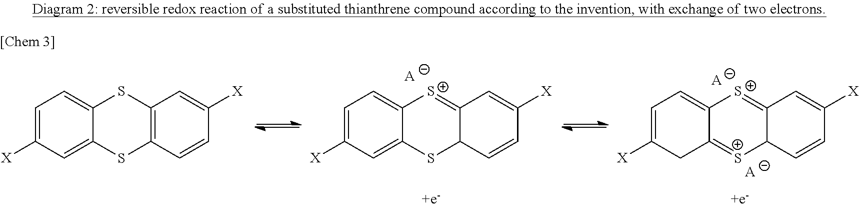

In addition, and without being bound by a particular theory, the presence of specific substituents in specific positions on the thianthrene unit results in an active material, within the positive electrode, having a particular crystal structure which differs from the crystal structure obtained in the case of an unsubstituted thianthrene molecule.

By way of illustration, FIG. 1 shows a comparison of the diffractogram, measured by powder X-ray diffraction (XRD), of unsubstituted thianthrene compared to 2,7-difluorothianthrene (DFTNT) according to the invention. The particular crystal structure obtained due to the presence of substituents in specific positions on the thianthrene ring, facilitates the transport of ions and electrons within the electrode, which makes it possible to obtain higher powers.

In addition, the presence within the positive electrode according to the invention, of an active material, an electronically conductive material, and optionally a binder, gives the electrode a porous structure which allows the electrolyte to penetrate the electrode, thus enabling the electrolyte to be in contact with the active material.

According to one particular embodiment, the invention relates to a positive electrode as defined above, wherein the compound of Formula 1 is such that R₁, R₂, R₃, R₄, R₅, R₆, R₇, and R₈ are selected independently among:
a hydrogen atom,
a halogen,
or a group selected among:
C₁ to C₁₀ linear or branched alkyl,
C₁ to C₁₀ linear or branched fluoroalkyl.

According to one particular embodiment, the invention relates to a positive electrode as defined above, wherein the compound of Formula 1 corresponds to the following Formula 2:

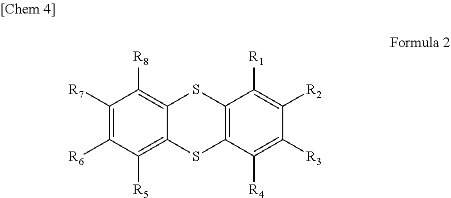

wherein R₁, R₂, R₃, R₄, R₅, R₆, R₇ and R₈ are as defined above for Formula 1, but are all different from H.

According to this embodiment, the thianthrene is substituted in all positions by a group other than H. Groups R₁, R₂, R₃, R₄, R₅, R₆, R₇, and R₈ are identical and in particular are —CH₃ or F.

According to one particular embodiment, the invention relates to a positive electrode as defined above, wherein the compound of Formula 1 corresponds to the following Formula 3:

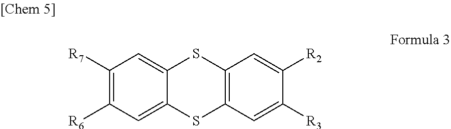

wherein R₂, R₃, R₆, and R₇ are as defined above for Formula 1, but are all different from H.

According to this embodiment, the thianthrene is substituted in positions 2, 3, 7 and 8 (JUPAC nomenclature) by a group other than H. Groups R₂, R₃, R₆, and R₇ are identical and in particular are
—CH₃ or F.

According to one particular embodiment, the invention relates to a positive electrode as defined above, wherein the compound of Formula 1 corresponds to the following Formula 4:

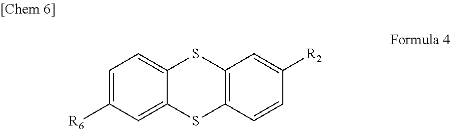

in which R₂ and R₆ are as defined above for Formula 1, but are all different from H.

According to this embodiment, thianthrene is substituted in positions 2 and 7 (IUPAC nomenclature) by a group other than H. Groups R₂ and R₆ are identical and in particular are —CH₃ or F.

According to another particular embodiment, the invention relates to a positive electrode as defined above, wherein the compound of Formula 1 is selected among:

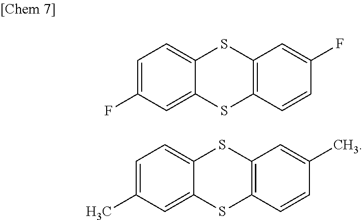

According to another particular embodiment, the invention relates to a positive electrode as defined above, wherein the redox compound of Formula 1 is present in the positive electrode in a content ranging from 20 to 80% by weight, preferably from 50 to 75% by weight, more preferably from 60 to 70% by weight, relative to the total weight of the positive electrode, excluding the current collector.

“Total weight of the positive electrode, excluding the current collector” is understood to mean the total weight of the active material, the electronically conductive material, and any binder.

Below 20%, the electrode does not contain sufficient redox compound to be able to store enough electricity, particularly for use in a battery.

Above 80%, the positive electrode cannot contain sufficient electronically conductive material and binder (if any).

For a redox compound of Formula 1 in a content ranging from “20 to 80%”, the following ranges are also meant: “20 to 60%”, “20 to 40%”, “40 to 80%”, “50 to 80%”, “60 to 80%”, “70 to 80%”, “40 to 75%”, “50 to 75%, “60 to 70%”, and “40 to 60%”.

The positive electrode based on organic material according to the invention further comprises an electronically conductive material.

For the electronically conductive material, it is possible to use any conductive material usually used in a positive electrode.

According to another particular embodiment, the electronically conductive material is selected among carbon black, acetylene black, graphite, carbon nanotubes, carbon fibers, and conductive organic polymers, the electronically conductive material being carbon black in particular.

As examples of carbon black, can be listed carbon blacks marketed under the names: Ketjenblack 600JD®, Ketjenblack 7003D®, and Timcal Ensaco 350G®.

Among the conductive organic polymers, can be listed as examples: poly(3,4-ethylenedioxythiophene) (PEDOT), poly(phosphoester-urethanes) (PPU), or polyaniline (PANI).

The nanoparticles are understood in particular to include metal nanoparticles such as copper or silver nanoparticles.

In particular, the electronically conductive material is present in the positive electrode in a content ranging from 10 to 60% by weight, in particular from 20 to 40% by weight, preferably from 25 to 30% by weight, relative to the total weight of the positive electrode excluding the current collector.

Below 10%, electronic percolation is not carried out and electrochemical reactions within the electrode cannot take place or only take place in part of the electrode.

Above 60%, its weight becomes predominant and greatly reduces the energy density of a battery manufactured with this electrode.

Electronically conductive material in a content ranging from “10 to 60%” is also understood to mean the following ranges: “10 to 50%”, “10 to 40%”, “10 to 30%”, “10 to 20%”, “25 to 30%”, “30 to 60%”, “40 to 60%”, “50 to 60%”, and “30 to 50%”, in particular “25 to 30%”.

The electrode based on organic active material according to the invention also comprises a current collector, for example in the form of a metal foil, in particular an aluminum or copper foil.

According to a preferred embodiment of the invention, the positive electrode may comprise a binder.

The binder is used to ensure good cohesion of the electrode. In the electrode according to the invention, any binder conventionally used in a positive electrode may be included.

According to one particular embodiment, the invention relates to a positive electrode based on organic active material as defined above, comprising, preferably consisting of:
an organic active material,
an electronically conductive material,
a current collector, and
optionally a binder.

According to another particular embodiment, the invention relates to a positive electrode as defined above, wherein the electrode comprises a binder, in particular a binder selected among polyvinylidenes, polyethylenes, polyacrylates, alkyd binders, glycerophthalic binders, polysiloxanes, polysiloxane-epoxides, polyurethanes, polysaccharides, latexes, carboxymethylcellulose and its derivatives, polyvinylidene fluoride, and polytetrafluoroethylene.

“Derivatives of carboxymethylcellulose” is understood to mean carboxyalkylcelluloses which comprise an alkyl group other than methyl in place of the methyl, for example such as an ethyl, propyl, or butyl group.

According to a preferred embodiment, the binder is selected in particular among carboxymethylcellulose and polyvinylidene fluoride.

According to another particular embodiment, the binder is present in the positive electrode in a content ranging from 5 to 25% by weight, preferably from 10 to 15% by weight, relative to the total weight of the positive electrode excluding the current collector.

Below 5%, the electrode could crumble/disintegrate.

Above 25%, the binder could have insulating effects, reducing electronic conductivity. Also, since the binder is not electroactive, the presence of too much binder reduces the amount of energy that can be stored.

A binder content ranging from “5 to 25%” is also understood to mean the following ranges: “5 to 20%”, “5 to 10%”, “10 to 25%”, and “15 to 25%”, in particular “10 to 15%”.

A second object of the invention is a method for preparing a positive electrode as defined above, wherein the method comprises:
1. placing said active material, said electronically conductive material, and optionally said binder, in contact with each other in order to obtain an electrode ink,
2. casting said electrode ink onto a current collector,
3. drying said electrode ink on the current collector.

Step 1 of placing the active material, the electronically conductive material, and optionally the binder in contact with each other is typically implemented by preparing a physical mixture of the two, or three, constituents and a liquid, followed by homogenization of the mixture, for example using a grinder or a mixer to obtain an ink.

The liquid is in particular an organic solvent, for example such as N-methyl-2-pyrrolidone (NMP). The use of an organic solvent facilitates drying the electrode at the end of step 3.

“Ink” is understood to mean, within the meaning of the invention, an electrode paste intended to be spread on a current collector.

Casting step 2 can be carried out using a doctor blade system, conventionally used for this purpose, and consists of spreading the ink on the surface of a current collector.

Drying step 3 evaporates the solvent used in step 1.

The electrode can then be punched out. For example, the punching can be done using an electrode punch. The punching step is used to achieve the desired physical shape and size of the electrode.

The inventors have surprisingly observed that the positive electrode according to the invention shows excellent electrochemical properties, enabling their use in a battery. Thus, electrochemical properties comparable to those observed for mineral-based electrodes have been observed.

In addition, the electrodes have good recyclability, and can be used for more than 100 cycles, in particular for more than 500 cycles, with no loss of electrochemical activity.

The positive electrode according to the invention makes it possible to reach a redox potential greater than 3.7 V versus Li⁺/Li⁰, with the LP30 electrolyte, in particular greater than 4 V. The LP30 electrolyte is a commercially available electrolyte (Merck), consisting of 1M LiPF₆ in a 1:1 mixture of ethylene carbonate/dimethyl carbonate.

A positive electrode comprising 2,7-difluorothianthrene thus makes it possible to reach an average redox potential of 4.15 V vs Li⁺/Li⁰ (within a Swagelok type half-cell with the LP30 electrolyte).

In comparison, a positive electrode based on unsubstituted thianthrene shows an average redox potential of 3.95 V vs Li⁺/Li⁰, under the same conditions.

According to one particular embodiment, the invention therefore relates to a positive electrode as defined above, having an average redox potential of 3.7 V to 4.2 V, versus Li⁺/Li⁰ with the LP30 electrolyte.

The redox potential, or reduction-oxidation potential, in the context of the compounds according to the invention, designates the propensity of the compounds for losing an electron.

Redox potential E⁰ is expressed in volts (V) and is measured relative to a reference electrode, Li⁺/Li⁰ in the invention. Measurement of the redox potential can be carried out in a reference cell, for example a Swagelok type cell.

The positive electrode according to the invention makes it possible to reach a specific capacity greater than 90 mAh g−1 of active material, after a first charge at rate C/5, versus Li⁺/Li⁰ with the LP30 electrolyte.

In addition, the organic positive electrodes according to the invention show excellent redox kinetics. For example, the use of a positive electrode comprising 2,7-difluorothianthrene makes it possible to reach a specific capacity of 96 mAh g⁻¹, 84 mAh g⁻¹, 79 mAh g⁻¹, 70 mAh g⁻¹, and 14 mAh g⁻¹ respectively for rate C/5, C/2, 1C, 2C, and 4C, while unsubstituted thianthrene offers capacities of 69 mAh g⁻¹, 51 mAh g⁻¹, 39 mAh g⁻¹, 20 mAh g⁻¹, and 0 mAh g⁻¹ for the same C rates.

“C rate” is understood to mean the time in hours to completely charge or discharge the electrode. Thus, a C/5 rate corresponds to a complete charge/discharge in 5 hours.

According to one particular embodiment, the invention therefore relates to a positive electrode as defined above, having a specific capacity ranging from 90 mAh g⁻¹ to 130 mAh g⁻¹, versus Li⁺/Li⁰ with the LP30 electrolyte, in the first charge-discharge cycle and at rate C/5.

The specific capacity, expressed in mAh/g, represents the electrical charge that the battery can provide from a fully charged state until its complete discharge, per unit mass. Measurement of the specific capacity can be carried out in a reference cell, for example a Swagelok type cell. In the context of the invention, these values are measured versus Li⁺/Li⁰ with the LP30 electrolyte.

A third object of the invention is a battery, in particular a rechargeable battery, comprising a positive electrode as defined above, a negative electrode, and a non-aqueous electrolyte.

For the “negative electrode” it is possible, by way of example, to use an electrode based on inorganic active material, e.g. an electrode of metal (lithium or sodium), graphite, carbon, silicon (or a silicon/graphite mixture), lithium titanium (La₂TiO₃ or Li₄TiOi₂, for example); or an electrode based on organic active material, e.g. based on carboxylate groups such as dilithium terephthalate, dilithium 2,6-naphthalene dicarboxylate, dilithium anthracene dicarboxylate, or based on diazo groups, or based on nitrile groups, such as tetracyanobenzoquinone.

An inorganic negative electrode is in particular an electrode based on metallic lithium.

An organic negative electrode is in particular an electrode based on dilithium 2,6-naphthalene dicarboxylate.

The choice of the negative electrode, organic or inorganic, depends on the type of battery desired.

“Non-aqueous electrolyte” is understood to mean, within the meaning of the invention, an electrolyte consisting of a non-aqueous liquid.

The use of a non-aqueous liquid makes it possible to avoid possible undesirable reactions with the compounds present in the negative electrode, such as metallic lithium.

According to one particular embodiment, the non-aqueous liquid is an aprotic solvent, in particular a solvent selected among an organic carbonate, an ether, an ester, a nitrile, or a mixture of these solvents.

According to one particular embodiment, the non-aqueous liquid is selected among: ethylene carbonate (EC), propylene carbonate (PC), vinylene carbonate (VC), butylene carbonate (BC), dimethyl carbonate (DMC), diethyl carbonate (DEC), ethyl methyl carbonate (EMC), ethylene vinyl carbonate (EVC), dimethyl ether, diglyme, triglyme, or combinations of these.

The non-aqueous liquid is in particular a mixture of ethylene carbonate and dimethyl carbonate.

According to a preferred embodiment, the non-aqueous liquid comprises a solubilized salt. In particular, the salt comprised in the non-aqueous solvent is a salt comprising a metal cation and an anion A⁻. The presence of the anion A⁻ allows the exchange of electrons with insertions of the anion A⁻, as illustrated in diagrams 1 and 2 above.

The metal cation is in particular a cation Mⁿ⁺, where n is equal to 1 or 2 and M is a metal. The metal cation is in particular selected among Li⁺, Na⁺, K⁺, Ca²⁺, and Mg²⁺, preferably Li⁺.

The anion is in particular an anion A^{m-} where m is 1 or 2. The anion is selected in particular among PF₆⁻, BF₄⁻, ClO₄⁻, (CF₃SO₂)₂N⁻, and (FSO₂)₂N⁻, preferably PF₆⁻.

The salt is in particular selected among: LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], or a lithium alkyl fluorophosphate.

According to a preferred embodiment, the salt is LiPF₆, which gives the best yields.

According to one particular embodiment, the concentration of said salt contained in the electrolyte is comprised from 1M to 5M, in particular comprised from 1M to 2M.

According to one particular embodiment, the invention relates to a battery as defined above, wherein the non-aqueous electrolyte is a solution of a salt in an organic solvent,
the salt being selected among LiPF₆, LiClO₄, and Li[N(FSO₂)₂], the salt being LiPF₆ in particular,
the organic solvent being a carbonate-based solvent, in particular diethyl carbonate, ethylene carbonate, propylene carbonate, dimethyl carbonate, or a mixture of these solvents.

Apart from the positive electrode, the negative electrode, and the electrolyte, the battery according to the invention can be equipped with other components that may possibly be necessary for the operation of a battery.

Thus, the battery can optionally be equipped with a separator, positioned between the positive electrode and the anode.

As non-limiting examples of separating materials that can be used in the battery, can be listed:
NAFION-type ion exchange membranes (copolymers based on sulfonated tetrafluoroethylene),
materials based on porous polymers such as, for example, sulfonated poly(ether-ether-ketones), polysulfones, polyethylene, polypropylene, ethylene-propylene copolymers, polyimides, polyvinyl difluorides,
porous ceramics,
porous isolated metals,
cation-conducting glasses,
zeolites.

The separator may for example take the form of a membrane, a matrix gel, or a sheet.

According to one particular embodiment, the separator is a fiberglass separator.

The battery according to the invention is in particular a rechargeable battery (also called an “accumulator”), in particular a lithium-type battery, in which the negative electrode is a metal electrode based on lithium.

The invention relates in particular to a battery as defined above, having a coulombic efficiency greater than 80%, in particular greater than 90%, more particularly greater than 95%.

The coulombic efficiency, or current efficiency, corresponds to the ratio of the quantity of electricity produced (in the discharge phase) and the quantity of electricity stored (in the charge phase), in the first cycle.

The invention relates in particular to a battery as defined above, having a cycling stability such that the coulombic efficiency after 500 cycles is greater than 60%, in particular greater than 70 or greater than 80%, in comparison to the first cycle.

### BRIEF DESCRIPTION OF THE DRAWINGS

The examples and figures below serve to illustrate the invention without limiting its scope.

FIG. 1 shows the diffractogram measured by powder X-ray diffractometry (XRD) for thianthrene and 2,7-difluorothianthrene (DFTNT).

FIG. 2 shows the potential-capacity profile of the 1^{st}, 2^{nd}, and 500^{th} cycles of the Li half-cell using a 2,7-difluorothianthrene electrode, Example 4 (1M LiPF₆ in 1:1 EC/DMC, window range 4.5 to 2.5 V).

FIG. 3 shows the variation in capacity as a function of the number of cycles for the half-cell described in Example 4 (2,7-difluorothianthrene).

FIG. 4 shows the potential-capacity profile of the 1^{st}, 2^{nd}, and 300^{th} cycles of the Li half-cell using a 2,7-dimethylthianthrene electrode, Example 5 (1M LiPF₆ in 1:1 EC/DMC, window range 4.5 to 2.5 V).

FIG. 5 shows the variation in capacity as a function of the number of cycles for the half-cell described in Example 5 (2,7-dimethylthianthrene).

FIG. 6 shows the potential-capacity profile of the 1^{st}, 2^{nd}, and 100^{th} cycles of organic full cells using 2,7-difluorothianthrene as the positive electrode and dilithium 2,6-naphthalene dicarboxylate, as specified in Example 7 (1M LiPF₆ in EC/DMC 1:1, window range 4.5 to 2.5 V).

FIG. 7 shows the variation in capacity as a function of the number of cycles for the full-cell described in Example 7.

FIG. 8 shows the potential-capacity profile of the 1^{st}, 2^{nd} and 500^{th} cycles of the Li half-cell using an unsubstituted thianthrene electrode, Example 6 (1M LiPF₆ in EC/DMC 1:1, window range 4.5 to 2.5 V).

FIG. 9 shows the variation in capacity as a function of the number of cycles for the half-cell described in Example 6 (unsubstituted thianthrene).

FIG. 10 shows the results of a throughput capacity test carried out at C/5, C/2, C, 2C, and 4C using a half-cell based on unsubstituted thianthrene, compared to lithium.

FIG. 11 shows the results of a throughput capacity test performed at C/5, C/2, C, 2C and 4C using a half-cell based on 2,6-difluorothianthrene, compared to lithium.

### DETAILED DESCRIPTION

### Examples

### Example 1 Synthesis of 2,7-difluorothianthrene (DFTNT)

2,7-difluorothianthrene was synthesized according to the procedure described by Edson et al (J. Polym. Sci. Part A: Polym. Chem., 2004, 42, 6353-6363).

4-Fluorobenzenethiol (5.06 mL, 6.09 g, 27 mmol) was weighed out and transferred to a 100 mL flask. Sulfuric acid (70 mL, 20-30% oleum) was slowly added to yield a blue solution which gradually turned purple. The solution was stirred using a magnetic bar for 22 hours at room temperature. Then 200 mL of ice water was added to the solution, which led to the formation of a brown precipitate. The suspension was filtered under vacuum, then the precipitate was successively washed with water, acetone, and diethyl ether. The crude product was dissolved in 100 mL of boiling acetic acid, then 2.68 g (41 mmol) of zinc dust was transferred into the solution. The solution was refluxed for 18 h, then the excess zinc was removed by filtration. The filtrate was poured into 200 mL of water, then the resulting suspension was filtered. The solid was washed with water and dried under vacuum for 8 hours at 80° C., to give a light brown crystalline solid.

Yield: 68%.

¹H-NMR (DMSO-d6): 7.62 (m, 2H). 7.54 (m, 2H), 7.27-7.22 (m, 2H).

¹³C-NMR (DMSO-d6): 162.63, 138.37, 130.37, 130.05, 116.26, 115.33.

### Example 2 Synthesis of 2,7-dimethyl thianthrene (DMTNT)

4-Methylbenzenethiol (3.35 g, 27 mol) was weighed out and transferred to a 250 mL flask. Sulfuric acid (40 mL, 20-30% oleum) was slowly added to yield ablue solution which gradually turned purple. The solution was stirred using a magnetic bar for 22 hours at room temperature. Then 200 mL of ice water was added to the solution, forming a brown precipitate. The product was vacuum filtered, then the precipitate was washed with water, acetone, and diethyl ether. Next, the solid was dried under vacuum for 8 hours at 80° C. to give a yellow and crystalline solid.

Yield: 41%.

¹H-NMR (DMSO-d6, 400 MHz) 7.31 (d, 1H), 7.26 (d, 1H), 6.99 (dd, 1H), 2.28 (s, 3H).

¹³C-NMR (CDCl₃, 400 MHz) 137.7, 135.9, 129.3, 128.5, 128.4, 0.9, 1.3.

### Example 3 Production of Positive Electrodes

General Procedure:

The positive electrode was prepared by mixing 1 g of active material with 0.41 g of electroconductive carbon (Ketjenblack® 600) and 0.21 g of binder (carboxymethylcellulose). The whole was blended in a mortar, then by using an Ultra-Turrax® homogenizer (IKA, Germany) for 30 minutes at 6000 rpm. Next, 6 mL of n-methyl pyrrolidone (NMP) was added and the whole was mixed for 90 minutes. After the mixing step, the paste was cast onto aluminum foil (thickness 20 μm) using a doctor blade system (350 μm blade clearance) then the solvent was evaporated on a hot plate for 2 hours at 60° C.

Round electrodes 13 mm in diameter were punched out and dried for 18 hours at 70° C. under vacuum.

The mass loading was quantified as approximately 2.5 mg cm².

Three positive electrodes were thus prepared according to this manufacturing method:

TABLE 1

| Positive electrode | Redox compound |
|---|---|
| 1 - according to the invention | 2,7-difluorothianthrene |
| 2 - according to the invention | 2,7-dimethylthianthrene |
| 3 - comparative electrode | Thianthrene |

### Example 4 Electrochemical Test with Positive Electrode 1 According to the Invention

The electrochemical performance of positive electrode 1, comprising the redox compound 2,7-difluorothianthrene, was determined using a Swagelok® type cell assembled in a glove box filled with argon (H₂O<0.1 ppm, O₂<0.1 ppm).

The glass fiber separator (Whatman®) was soaked with a solution of 1M LiPF₆ in a 50:50 wt % ethylene carbonate (EC): dimethyl carbonate (DMC) mixture (electrolyte LP30, Merck) as the electrolyte.

The cell was tested in galvanostatic mode using a Biologic VMP-3 instrument (Biologic SAS, France) with a voltage window of 2.5 to 4.5 V at rate 2C.

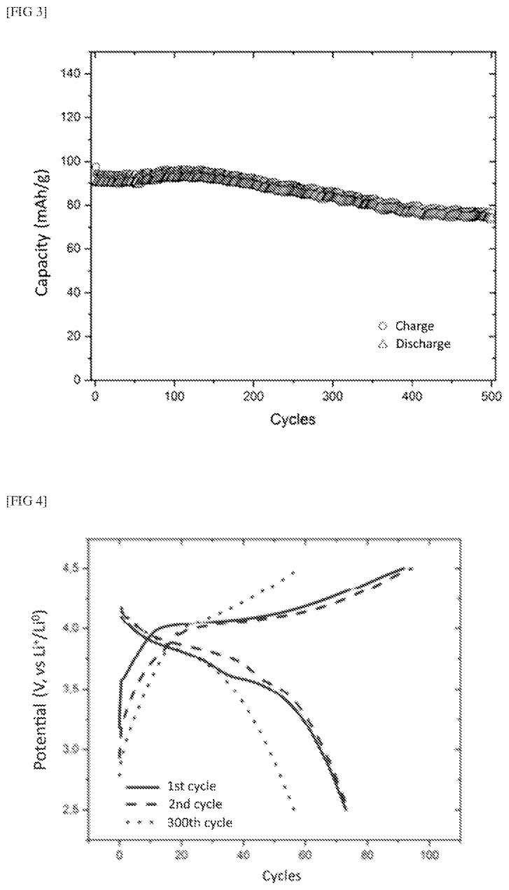

The half-cell showed an average redox potential of 4.15 V vs Li⁺/Li⁰, with the LP30 electrolyte, and a specific capacity of 94 mAh g⁻¹ after the charging phase. A reversible capacity of 90 mAh g⁻¹ was observed, with an overall coulombic efficiency of 96% (FIG. 2).

After 500 cycles, a reversible specific capacity of 73 mAh g⁻¹ was observed (80% capacity retention compared to the first cycle). The coulombic efficiency was quantified at 97% (FIG. 3).

As for the rate performance, a specific capacity of 96 mAh g⁻¹, 84 mAh g⁻¹, 79 mAh g⁻¹, 70 mAh g⁻¹, and 14 mAh g⁻¹ was respectively measured for rates C/5, C/2, C, 2C, and 4C.

### Example 5 Electrochemical Test with Positive Electrode 2 According to the Invention

The electrochemical performance of positive electrode 2, comprising the redox compound 2,7-dimethylthianthrene, was determined using a Swagelok® type cell assembled in a glove box filled with argon (H₂O<0.1 ppm, O₂<0.1 ppm).

The glass fiber separator (Whatman®) was soaked with a solution of 1M LiPF₆ in a 50:50 wt % ethylene carbonate (EC):dimethyl carbonate (DMC) mixture (electrolyte LP30, Merck) as the electrolyte.

The cell was tested in galvanostatic mode using a Biologic VMP-3 instrument (Biologic SAS, France) with a voltage window of 2.5 to 4.5 V at rate 2C.

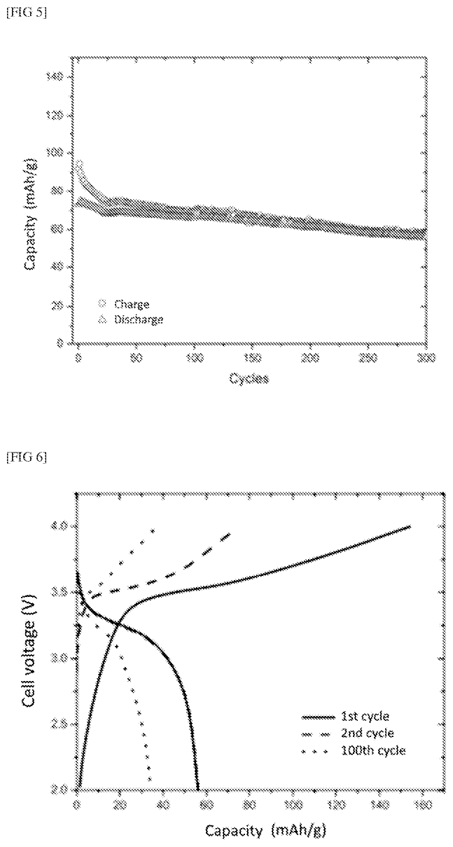

The half-cell showed an average redox potential of 3.80 V vs. Li⁺/Li⁰, with the LP30 electrolyte, with a specific capacity of 92 mAh g⁻¹ after the charging phase. A reversible capacity of 73 mAh g⁻¹ was observed, for an overall coulombic efficiency of 96% (FIG. 4). After 300 cycles, a reversible specific capacity of 56 mAh g⁻¹ was observed (58 mAh g⁻¹ charge), for a capacity retention of 77% compared to the first cycle and a coulombic efficiency of 97% (FIG. 5).

### Example 6 Electrochemical Test with Positive Electrode 3—Comparative Example

The electrochemical performances of the composite of unsubstituted thianthrene electrodes were determined using a Swagelok® type cell assembled in a glove box filled with argon (H₂O<0.1 ppm, O₂<0.1 ppm).

The glass fiber separator (Whatman®) was soaked with a solution of 1M LiPF₆ in a 50:50 wt % ethylene carbonate (EC):dimethyl carbonate (DMC) mixture (electrolyte LP30, Merck) as the electrolyte.

The cell was tested in galvanostatic mode using a Biologic VMP-3 instrument (Biologic SAS, France) with a voltage window of 2.5 to 4.5 V at rate C/5.

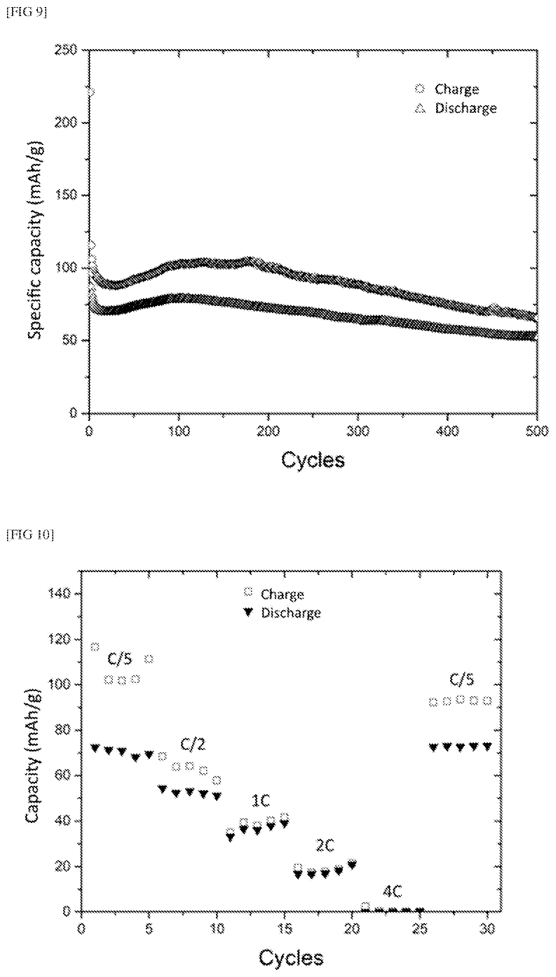

The half-cell showed an average redox potential of 3.95 V versus Li⁺/Li⁰, with the LP30 electrolyte, with a specific capacity of 221 mAh g⁻¹ after the charging phase. A reversible capacity of 96 mAh g⁻¹ was observed, for an overall coulombic efficiency of 43% (FIG. 8).

After 500 cycles, a reversible specific capacity of 52 mAh g⁻¹ was observed (for a capacity retention of 54% compared to the first cycle). The coulombic efficiency was quantified at 80% (FIG. 9). For the rate performance, a specific capacity of 69 mAh g⁻¹, 51 mAh g⁻¹, 39 mAh g⁻¹, and 20 mAh g⁻¹ was respectively measured for rate C/5, C/2, C, and 2C; at rate 4C, the half-cell is not able to provide any capacity.

### Example 7 Electrochemical Test of an Organic Full Cell Composed of Compound 1 and Li₂Ndc

An organic full cell, based on a two-ion mechanism, was prepared and assembled. The electrode based on 2,7-difluorothianthrene was prepared as described in Example 3. The negative electrode was prepared using dilithium 2,6-naphthalene dicarboxylate (Li₂NDC) as the active material.

The dilithium 2,6-naphthalene dicarboxylate was synthesized according to the method described by Ogihara (Angew. Chem. Int. Ed. Engl., 2014, 53(43), p. 11467-11472).

1 g of active material was mixed with 0.38 g of conductive carbon black (TIMCAL SUPER C45) and 0.15 g of binder (carboxymethylcellulose), for a final proportion of 65/25/15 wt %. Next, 5 ml of water were added and the paste was mixed for another 90 minutes. The paste was cast on copper foil and dried at 60° C. for 4 hours.

An electrode 13 mm in diameter was punched out and dried overnight at 100° C. under vacuum.

The mass loading was quantified as approximately 4.0 mg cm-2. The electrochemical tests were carried out using a coin cell type of cell, assembled in a glove box filled with argon (H₂O<0.1 ppm, O₂<0.1 ppm). The two organic electrodes were separated by a glass fiber separator (Whatman®) which was soaked with a solution of 1M LiPF₆ in a 50:50 wt % ethylene carbonate (EC):dimethyl carbonate (DMC) mixture (electrolyte LP30, Merck) as the electrolyte.

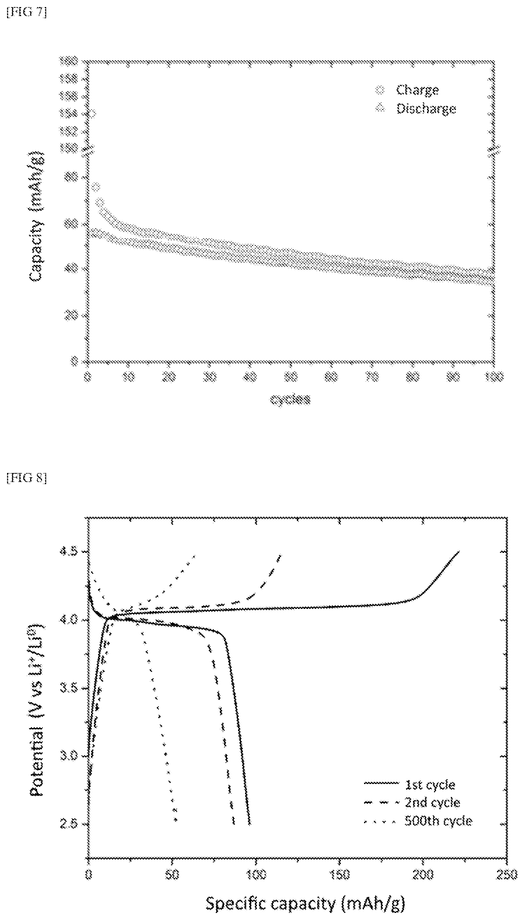

The cell was tested in galvanostatic mode using a Biologic VMP-3 instrument (Biologic SAS, France) with a voltage window of 4.0-2.0 V at rate 1C. As shown in FIG. 6, the performance qualities of this dual-ion battery, i.e. a battery in which the anions take part in the positive oxidation of the electrodes, while the cations take part in the negative reduction of the electrodes to counterbalance the charge during charge/discharge cycles, are effectively confirmed.

The organic full cell showed an average redox potential of 3.40 V vs Li⁺/Li⁰, with a specific capacity of 154 mAh g⁻¹ after the charging phase, with a reversible capacity of 56 mAh g⁻¹, for an overall coulombic efficiency of 36% (FIG. 6).

After 100 cycles, a reversible specific capacity of 35 mAh g⁻¹ was observed (37 charges), for a capacity retention of 63% compared to the first cycle. The coulombic efficiency was quantified at 95% (FIG. 7).

### DISCUSSION

The above examples show that the presence of substituents on the thianthrene ring leads to an increase in the average insertion potential, or redox potential. In the case of unsubstituted thianthrene, an insertion potential of 3.95 V relative to Li⁺/Li⁰ is observed (example 6). On the other hand, an insertion potential of 4.15 V relative to Li⁺/Li⁰ was observed in the presence of two fluorine atoms (2,7-difluorothianthrene, example 4).

Furthermore, 2,7-difluorothianthrene also showed better redox kinetics, which can be seen from the different rate performances obtained with the two materials.

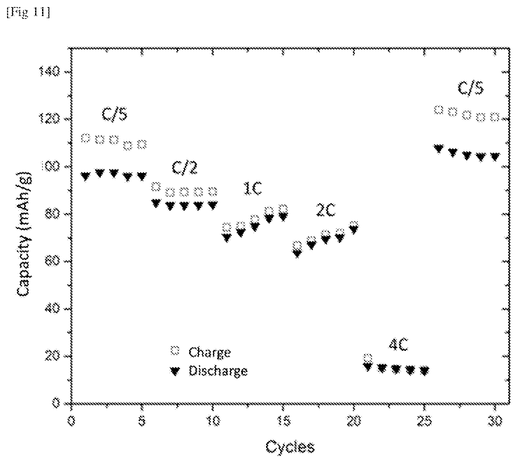

Thus, FIG. 10 and FIG. 11 show the specific capacities as a function of the applied current density, for electrodes of thianthrene and 2,7-difluorothianthrene respectively.

The 2,7-difluorothianthrene derivative shows a specific capacity of 96 mAh g⁻¹, 84 mAh g⁻¹, 79 mAh g⁻¹, 70 mAh g⁻¹, and 14 mAh g⁻¹ at rate C/5, C/2, 1C, 2C, and 4C, respectively; while unsubstituted thianthrene offers capacities of 69 mAh g⁻¹, 51 mAh g⁻¹, 39 mAh g⁻¹, 20 mAh g⁻¹, and 0 mAh g⁻¹ for the same rates respectively.

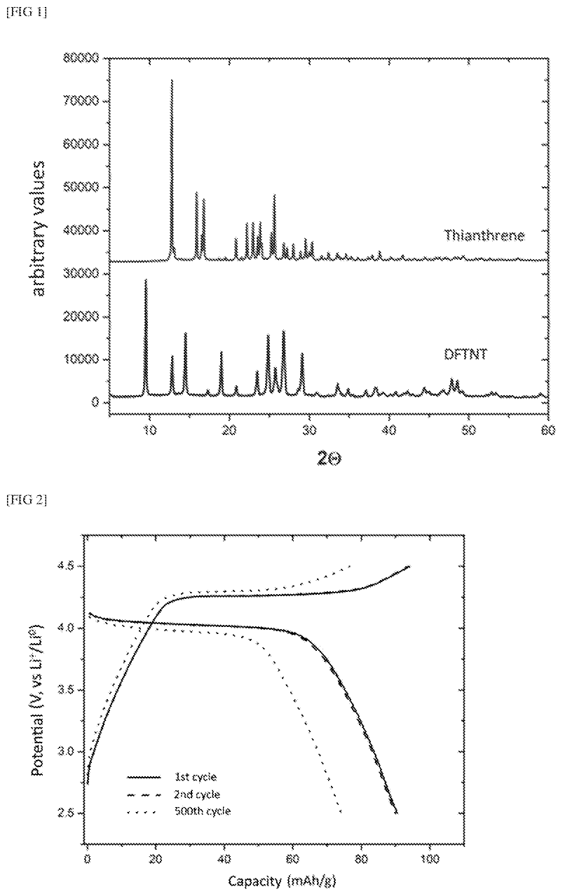

Therefore, the 2,7-difluorothianthrene-based electrode is characterized by redox kinetics superior to those of an electrode based on unsubstituted thianthrene. This result can be explained by the better ionic/electronic conductivity of the crystal structure of substituted thianthrene compared to that of unsubstituted thianthrene. The structural differences have been highlighted by comparing the diffraction patterns of the two materials, illustrated in FIG. 1.

1. A positive electrode based on organic active material, comprising or consisting of:
an organic active material,
an electronically conductive material, and
a current collector,
wherein the active material is a redox compound of Formula 1: 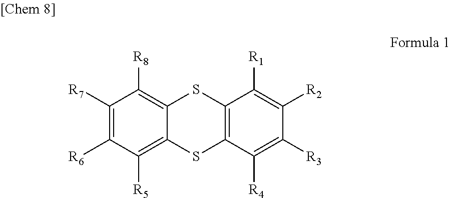
wherein:
R₁, R₂, R₃, R₄, R₅, R₆, R₇ and R₈ are independently selected among:
a hydrogen atom,
a halogen,
or a group selected among:
C₁ to C₅₀ linear or branched alkyl,
C₁ to C₅₀ linear or branched fluoroalkyl,
—CO₂H, optionally in salified form,
—SO₂OH, optionally in salified form,
—PO(OH)₂, optionally in salified form,
—PO(ORₐ)₂, where Rₐ is a C₁ to C₁₀ linear or branched alkyl group,
—CN,
amine,
—OH,
—OR_{b}, where R_{b} is a C₁ to C₅₀ linear or branched alkyl group,
—CHO,
—CO—R_{c}, where R_{c} is a C₁ to C₅₀ linear or branched alkyl group,
and wherein:
R₁, R₂, R₃, R₄, R₅, R₆, R₇ and R₈ are different from H, or
R₁, R₄, R₅, and R₅ are H, and R₂, R₃, R₆ and R₇ are different from H, or
R₁, R₃, R₄, R₅, R₇ and R₈ are H, and R₂ and R₆ are different from H.

2. The positive electrode according to claim 1, wherein the compound of Formula 1 is such that
R₁, R₂, R₃, R₄, R₅, R₆, R₇, and R₈ are selected independently among:
a hydrogen atom,
a halogen,
or a group selected among:
C₁ to C₁₀ linear or branched alkyl,
C₁ to C₁₀ linear or branched fluoroalkyl.

3. The positive electrode according to claim 1, wherein the compound of Formula 1 is selected among:

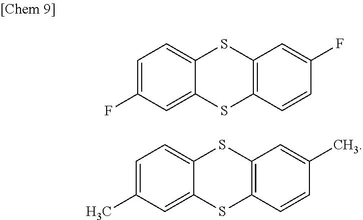

4. The positive electrode according to claim 1, wherein the redox compound of Formula 1 is present in the positive electrode in a content ranging from 20 to 80% by weight, relative to the total weight of the positive electrode excluding the current collector.

5. The positive electrode according to claim 1, wherein the electronically conductive material is selected among carbon black, acetylene black, graphite, carbon nanotubes, carbon fibers, and conductive organic polymers.

6. The positive electrode according to claim 1, wherein the electronically conductive material is present in the positive electrode in a content ranging from 10 to 60% by weight, relative to the total weight of the positive electrode excluding the current collector.

7. The positive electrode according to claim 1, wherein the electrode comprises a binder.

8. The positive electrode according to claim 1, wherein the electrode comprises a binder, and wherein binder is present in the positive electrode in a content ranging from 5 to 25% by weight, relative to the total weight of the positive electrode excluding the current collector.

9. A method for preparing the positive electrode according to claim 1, wherein the method comprises:
(1) placing said active material, said electronically conductive material, and optionally said binder, in contact with each other to obtain an electrode ink,
(2) casting said electrode ink onto a current collector,
(3) drying said electrode ink on the current collector.

10. A battery comprising the positive electrode according to claim 1, a negative electrode, and a non-aqueous electrolyte.

11. The battery according to claim 10, wherein the non-aqueous electrolyte is a solution of a salt in an organic solvent,
the salt being selected among LiPF₆, LiClO₄, and Li[N(FSO₂)₂],
the organic solvent being a carbonate-based solvent.

12. The positive electrode according to claim 1, wherein the electrode comprises a binder selected among polyvinylidenes, polyethylenes, polyacrylates, alkide binders, glycerophtalic binders, polysiloxanes, polysiloxane-epoxides, polyurethanes, polysaccharides, latexes, carboxymethylcellulose and its derivatives, polyvinylidene fluoride, and polytetrafluoroethylene.

13. The battery according claim 10, wherein the battery is a rechargeable battery.

14. The battery according to claim 10, wherein the non-aqueous electrolyte is a solution of a salt in an organic solvent,
the salt being LiPF₆,
the organic solvent being chosen from diethyl carbonate, ethylene carbonate, propylene carbonate, dimethyl carbonate, or a mixture of these solvents.
